(19) United States
(12) Patent Application Publication
(10) Pub. No.: US 2003/0053381 A1
(43) Pub. Date: Mar. 20, 2003

(54) Driving apparatus and driving method for actuator, and information recording / reproducing apparatus

(75) Inventors: Kazuo Takahashi, Tsurugashima-shi (JP); Yoshitsugu Araki, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/228,191

(22) Filed: Aug. 27, 2002

(30) Foreign Application Priority Data
Aug. 29, 2001 (JP) 2001-260355

(51) Int. Cl. G11B 7/085

(52) U.S. Cl. 369/30.24; 369/53.15

(57) ABSTRACT

A driving apparatus (100, 200, 300, 400, 506) for driving an actuator (507) with electric current is provided with: a current monitor device for generating a voltage corresponding to an electric current that passes through the actuator and that includes the counter electromotive force component generated according to the movement of the actuator; and a feedback device for giving negative of the generated voltage. The feedback device makes it difficult for the actuator to move by giving the negative feedback with a large gain in presence of a defect, in accessing, in a stop condition, and the like.

### BACKGROUND OF THE INVENTION

1. Field of the Invention

The present invention generally relates to a driving apparatus for and a driving method of driving or applying the brake to an actuator to be disposed on an optical pickup at an optical disc apparatus such as a DVD player, a DVD recorder, and the like. The present invention also relates to an information recording/reproducing apparatus, such as an optical disc apparatus and the like, equipped with such a driving apparatus.

2. Description of the Related Art

An optical pickup is provided with various actuators such as an actuator for focus control, an actuator for tracking control, and the like. A driving apparatus for driving such an actuator is designed to have an actuator move arbitrarily within a predetermined range and at a necessary acceleration, and it is also designed to keep its posture with a predetermined accuracy.

Conventionally, this type of driving apparatus is intended to obtain an appropriate electric current output, i.e. appropriate driving force, mainly with a voltage as an input, when it drives an actuator such as the one of moving coil type, of voice coil type, or the like, which uses electromagnetic force as driving force. Especially, in typical operation, the driving apparatus is designed to feedback an electric current, which passes through the actuator, by a resistance for monitoring the electric current, in order to avoid the effect of coil inductance or the like and to obtain an appropriate voltage output with respect to the input. Incidentally, “in typical operation” in this specification means that an actuator is in the middle of performing typical record or an operation for reproducing, such as a tracking operation, a focus operation, and the like, on an optical pickup, other than “in presence of a defect”, “in slider or carriage movement”, “in a stop condition”, or the like, as will be described later.

Moreover, this type of driving apparatus is designed such that counter electromotive force that comes with the movement of an actuator does not affect driving in typical operation, and an input and the operation of an actuator is almost open control.

If the driving apparatus is constructed to substantially perform open control as described above, it is all right in typical operation. However, it has a problem in a stop condition. Namely, in such a construction, the optical pickup may bump into or crash into an optical disc face, which is disposed extremely close to the optical pickup, because of an actuator's wobble caused by the vibration of a vehicle or by carrying in a stop condition of an optical disc apparatus or the optical pickup (i.e. in the condition of not recording nor reproducing) of on-vehicle electronic equipment, a portable device, or the like.

Moreover, if it is constructed to substantially perform open control as described above, it has such a problem that the actuator excessively react an error signal and thus it is forced to operate beyond the limits and inappropriately in presence of a defect such as in the case that there are some dust, scratches, and the like on an optical disc.

Furthermore, if it is constructed to substantially perform open control as described above, a head actuator, such as the one for focus control, the one for tracking control, or the like, wobbles greatly when the whole optical pickup moves in accessing by the carriage or slider movement of the optical pickup, which may cause troubles and which may bring disadvantage in focus control or tracking control immediately after accessing.

In order to specially block or apply the brake to the movement of an actuator in a stop condition, in presence of a defect, in slider movement, or the like on an optical pickup described above, a braking mechanism such as a brake or the like is required apart from a driving mechanism of the actuator. At the same time, there arises a need for control by a CPU (Central Processing Unit) or the like, which supplies a braking signal to the braking mechanism. Consequently, this extremely complicates a structure of the driving apparatus and its control method. Especially, as for this kind of optical pickup, as it records in higher density, a defect tends to be generated by the tinier amount of dust and scratches. This problem is extremely serious under a general request, which is high density recording.

Moreover, the driving apparatus of an actuator needs to allow the actuator to move arbitrarily within a predetermined range and at a required acceleration, as well as to keep its posture with a predetermined accuracy, so that it is basically not allowed to easily and simply design such that the actuator cannot move smoothly due to conditions such as in presence of a defect, in accessing, in a stop condition, and the like.

### SUMMARY OF THE INVENTION

It is therefore an object of the present invention to provide a driving apparatus and a driving method for an actuator, which can apply the brake to the actuator in presence of a defect, in accessing, in a stop condition, and the like, by using a relatively simple device structure and a control method, as well as an information recording/reproducing apparatus such as an optical disc apparatus and the like equipped with such a driving apparatus.

The above object of the present invention can be achieved by a first driving apparatus for driving an actuator according to electric current control, provided with: a current monitor device for generating a voltage corresponding to an electric current that passes through the actuator and that includes a counter electromotive force component generated according to a movement of the actuator; and a feedback device for giving negative feedback of the generated voltage.

According to the first driving device for an actuator, the current monitor device generates a voltage corresponding to an electric current that passes through the actuator and that includes a counter electromotive force component generated according to a movement of the actuator. Then, the feedback device gives negative feedback of the generated voltage. Consequently, when the counter electromotive force is generated, it becomes difficult for the actuator to move in response to it.

Therefore, it is possible to prevent an actuator from reacting an error signal excessively and it is not necessary to operate the actuator beyond the limits and inappropriately in presence of a defect, such as in the case that there are some dust, scratches, and the like on an optical disc, for example. On that account, it is possible to preferably deal with the situation even in the case of recording as high density, in which a defect may be generated with the tiny amount of dust and scratches.

Moreover, it is possible to prevent a head actuator, such as the one for focus control, the one for tracking control, or the like, from wobbling greatly when the whole pickup moves in accessing by the carriage or slider movement of the pickup, which may reduce cause of troubles and which enables a good focus control or and a good tracing control immediately after accessing.

Furthermore, it is possible to prevent an actuator's wobble caused by the vibration of a vehicle or by carrying in a stop condition of an optical disc apparatus or the optical pickup of on-vehicle electronic equipment, a portable device, or the like, and it is possible to avoid the possibility that the optical pickup bumps into or crashes into an optical disc.

In addition to that, in order to specially block or apply the brake to the movement of an actuator in a stop condition of an optical pickup, in presence of a defect, in slider movement, or the like described above, it is not necessary to install a braking mechanism such as a brake or the like apart from a driving mechanism of an actuator, and also there is no need for control by a CPU (Central Processing Unit) or the like, which supplies a braking signal to the braking mechanism.

As a result of these, it becomes possible to apply the brake to an actuator in presence of a defect, in accessing, in a stop condition, or the like, as well as simplifying the machine structure of a driving apparatus and its control method.

In one aspect of a first driving apparatus for an actuator of the present invention, the current monitor device is constructed to generate a voltage corresponding to the counter electromotive force component.

According to this aspect, the current monitor device generates a voltage corresponding to (only) the counter electromotive force component generated according to the movement of the actuator. Then, negative feedback of the generated voltage is given by the feedback device. Consequently, when the counter electromotive force is generated, it becomes difficult for the actuator to move in response to generation of the counter electromotive force.

Therefore, it is possible to totally eliminate such a construction that performs a gain change, a switch control, and the like, being aware of the distinction of conditions such as in presence of a defect, in accessing, in a stop condition, and the like. Moreover, it is possible to avoid the situation that an actuator has difficulty in moving unnecessarily in typical operation, which is extremely useful in practice.

In this aspect, the current monitor device is equipped with: a first resistance connected between a ground and one terminal of an input side of an inductance, which electromagnetically generates driving force for driving the actuator; a second resistance connected between the first resistance and the one terminal of the input side of the inductance; and a third resistance connected between the ground and another terminal of the inductance, and Ze:R_{L}=R_{Y}:R_{X} is applicable when an electric impedance of the inductance is Ze and the values of the first resistance, the second resistance, and the third resistance are R_{X}, R_{L}, and R_{Y}, respectively.

By constituting in this manner, it is possible to generate a voltage corresponding to (only) the amount of counter electromotive force generated according to the movement of the actuator relatively simply with the three resistances by the current monitor device.

In one aspect of the first driving device for an actuator of the present invention, the feedback device is provided with a first switch device to be opened or closed according to a first braking signal and gives negative feedback of the generated voltage selectively by opening or closing the first switch device.

According to this aspect, the first switch device provided with the feed back device is opened or closed according to the first braking signal. Then, by opening or closing the first switch device, the feedback device gives negative feedback of the generated voltage selectively.

For example, in the condition such as in presence of a defect, in accessing, in a stop condition, and the like, if the first switch device is closed according to the first braking signal, the negative feedback of the voltage corresponding to the electric current that includes the counter electromotive force component generated according to the movement of an actuator is given. Therefore, it is possible to make it difficult for the actuator to move in response to the counter electromotive force. On the other hand, in the case of being in typical operation, if the first switch device is opened according to the first braking signal, the negative feedback is not given. Therefore, this does not make it difficult for the actuator to move.

In one aspect associated with this first switch device, the feedback device may be provided with a resistance connected in parallel to the first switch device.

By constituting in this manner, when the first switch device is closed, a negative feedback route is established with the first switch device and the resistance connected in parallel to the first switch device, which can relatively increase a feedback gain. On the other hand, when the first switch device is opened, the negative feedback route is established with only the resistance connected in parallel to the first switch device, which can relatively decrease the feedback gain. If all of the negative feedback routes are cut, it is possible to make driving of the actuator unsteady in typical operation according to circumstances. Therefore, the install of the resistance as described above is extremely useful.

In another aspect associated with this first switch device, the driving apparatus may be provided with a second switch device to be opened or closed according to a second braking signal on an electric current input route for driving of the actuator.

By constituting in this manner, in presence of a defect, in slider movement, in a stop condition, or the like, it is possible to give negative feedback of a voltage corresponding to an electric current including only the counter electromotive force component generated according to the movement of the actuator, by opening the second switch device according to the second braking signal to cut the input route. On the other hand, in typical operation, it is possible to input an electric current for driving, by closing the switch second device according to the second braking signal.

In this case, a single common signal is used as the first braking signal and the second braking signal.

By constituting in this manner, the two switch devices can be on the basis of the common signal, so that it is possible to simplify the apparatus structure and a control method The above object of the present invention can be achieved by a second driving apparatus for driving an actuator with electric current, provided with: a current monitor device for generating a voltage corresponding to an electric current that passes through the actuator; and a feedback device for selectively giving negative feedback of the generated voltage with a first gain or a second gain, which is larger than the first gain, according to a first braking signal.

According to the second driving device for an actuator, the current monitor device generates a voltage corresponding to an electric current that passes through the actuator, and that includes the counter electromotive force component generated according to the movement of the actuator. Then, the feedback device selectively gives negative feedback of the generated voltage with a first gain or a second gain, which is larger than the first gain, according to the first braking signal. Consequently, if the negative feedback is given with a small gain according to the first braking signal in typical operation, it is possible to make it easy for the actuator to move. On the other hand, if the negative feedback is given with a large gain according to the first braking signal in presence of a defect, in accessing, in a stop condition, and the like, it is possible to make it difficult for the actuator to move.

Moreover, it is not necessary to install a braking mechanism such as a brake or the like apart from a driving mechanism of an actuator in order to specially block or apply the brake to the movement of an actuator in a stop condition of an optical pickup, in presence of a defect, in slider movement, or the like described above.

As a result of these, it becomes possible to apply the brake to an actuator in presence of a defect, in accessing, in a stop condition, or the like, as well as simplifying the machine structure of a driving apparatus and its control method.

In one aspect associated with the first switch device of the first driving device for an actuator of the present invention, or in one aspect of the second driving device for an actuator of the present invention, the first and/or second braking signals are supplied in response to presence of a defect of a recording medium, when a recording operation or a reproducing operation is performed on the recording medium through a pickup on which the actuator is disposed.

According to this aspect, the first and/or second braking signals are supplied to the first switch device, the second switch device and/or the feedback device in response to presence of a defect. According to the first and/or second braking signals, the first and/or second switch devices are opened, or a gain related to the negative feedback at the feedback device is changed. Therefore, it is possible to prevent the actuator from reacting an error signal excessively in presence of a defect, so that it is necessary to operate the actuator beyond the limits and inappropriately.

In this aspect, the driving apparatus is further provided with a control device for detecting the defect on the basis of an optical detection signal outputted by the pickup, wherein the control device outputs at least one of the first and second braking signals in response to the detection of the defect.

By constituting in this manner, in presence of a defect such as in the case that there are some dust, scratches, and the like on an optical disc, the control device detects the defect on the basis of the optical detection signal outputted by the pickup and outputs the first and/or second braking signals in response to the detection of this defect, so that it becomes possible to control the change of a gain or to open the switch device in presence of a defect, automatically.

In another aspect associated with the first switch device of the first driving device for an actuator of the present invention, or in another aspect of the second driving device for an actuator of the present invention, the first and/or second braking signals are supplied when a slider movement or a carriage movement of a pickup on which the actuator is disposed occurs.

According to this aspect, the first and/or second braking signals are supplied to the first and/or switch devices or the feedback device in response to the slider movement or the carriage movement of the pickup, when accessing operation of the pickup, or the like. Then, according to the first and/or second braking signals, the first and/or second switch devices are opened, or a gain related to the negative feedback at the feedback device is changed. Therefore, it is possible to prevent a head actuator, such as the one for focus control, the one for tracking control, or the like, from wobbling greatly in accessing, which may reduce cause of troubles and which enables a good focus control or and a good tracing control immediately after accessing.

In this aspect, the driving apparatus for an actuator is further provided with a control device for outputting an access command that orders the pickup to perform the slider movement or the carriage movement to a predetermined address location on a recording medium. Furthermore, the control device is constructed to output the first and/or second braking signals in response to the output of the access command.

By constituting in this manner, the control device outputs an access command and outputs the first and/or second braking signal in response to the output of the access command in accessing, so that it becomes possible to control the change of a gain or to control the opening of the switch device in accessing, automatically.

In another aspect associated with the first switch device of the first driving device for an actuator of the present invention, or in another aspect of the second driving device for an actuator of the present invention, the first and/or second braking signals are supplied in a stop condition of an operation of a pickup on which the actuator is disposed.

According to this aspect, the first and/or second braking signals are supplied when stopping a pickup on which the actuator is disposed. Then, the first and/or second switch devices are opened, or a gain related to the negative feedback at the feedback device is changed according to first and/or second braking signals. Therefore, it is possible to prevent an actuator's wobble caused by the vibration of a vehicle or by carrying in a stop condition of an optical disc apparatus or the optical pickup of on-vehicle electronic equipment, a portable device, or the like, and it is possible to avoid the possibility that the optical pickup bumps into or crashes into an optical disc.

In this aspect, the driving apparatus for an actuator is further provided with a control device for determining whether or not the pickup is in a stop condition of its operation, the control device outputting the first and/or second braking signals in response to the determination of being in a stop condition of the pickup.

By constituting in this manner, in a stop condition, the control device determines that and outputs the first and/or second braking signals in response to the determination, so that it becomes possible to control the change of a gain or to control the opening of the switch device in a stop condition, automatically.

In another aspect of the first or second driving apparatus of the present invention, the feedback device is provided with an amplification device for amplifying the generated voltage and gives negative feedback of the amplified voltage.

According to this aspect, it becomes possible to give negative feedback of the generated voltage, which is generated by the current monitor device, by the amplification device provided for the feedback device. Thus, if the negative feedback is given with a small gain without amplifying with the amplification device in typical operation, it becomes possible to make it easy for the actuator to move. On the other hand, if the negative feedback is given with a large gain by amplifying with the amplification device in presence of a defect, in accessing, in a stop condition, or the like, it becomes possible to make it difficult for the actuator to move.

In this aspect, the feedback device further comprises a resistance connected in parallel to the amplification device.

By constituting in this manner, even when not amplifying with the amplification device, it is possible to establish a reasonable route for negative feedback because of the presence of the resistance. Especially, in the case that the amplification device does not perform amplification, if the negative feedback is completely stopped, it is possible to make driving of the actuator unsteady in typical operation according to circumstances. Therefore, the install of the resistance as described above is extremely useful.

In another aspect of the first or second driving apparatus of the present invention, the actuator is the one for tracking driving or the one for focus driving of a pickup.

According to this aspect, it becomes possible to control the movement for the actuator for tracking control and the actuator for focus control in presence of a defect, in accessing, in a stop condition, or the like, so that it is not necessary to install a braking mechanism such as a brake and the like.

The above object of the present invention can be achieved by a first driving method of driving an actuator according to electric current control, provided with: a current monitor process of generating a voltage corresponding to an electric current that passes through the actuator and that includes a counter electromotive force component generated according to a movement of the actuator; and a feedback process of giving negative feedback of the generated voltage.

According to the first driving method for an actuator, the current monitor process generates a voltage corresponding to an electric current that passes through the actuator and that includes a counter electromotive force component generated according to a movement of the actuator. Then, the feedback process gives negative feedback of the generated voltage. Consequently, when the counter electromotive force is generated, it becomes difficult for the actuator to move in response to it.

Therefore, as is the case with the first driving device for an actuator of the present invention described above, it becomes possible to apply the brake to an actuator in presence of a defect, in accessing, in a stop condition, or the like, as well as simplifying the machine structure of a driving apparatus and its control method.

The above object of the present invention can be achieved by a second driving method of driving an actuator with electric current, provided with: a current monitor process of generating a voltage corresponding to an electric current that passes through the actuator; and a feedback process of selectively giving negative feedback of the generated voltage with a first gain or a second gain, which is larger than the first gain, according to a first braking signal.

According to the second driving method for an actuator, the current monitor process generates a voltage corresponding to an electric current that passes through the actuator and that includes the amount of counter electromotive force generated according to the movement of the actuator. Then, the feedback process gives negative feedback of the generated voltage with a first gain or a second gain, which is larger than the first gain, according to the first braking signal.

Therefore, as is the case with the first driving device for an actuator of the present invention described above, it becomes possible to apply the brake to an actuator in presence of a defect, in accessing, in a stop condition, or the like, as well as simplifying the machine structure of a driving apparatus and its control method.

The above object of the present invention can be achieved by an information recording/reproducing apparatus provided with: a driving apparatus for an actuator of the present invention described above (including its various aspects); the actuator; a pickup movable by the actuator; and an information recording/reproducing device for performing at least one of record and reproduction of information by the pickup.

According to the information recording/reproducing apparatus of the present invention, it is provided with a driving apparatus for an actuator of the present invention described above, so that it is possible to realize an information recording/reproducing apparatus, which records and reproduces on a recording medium and which can apply the brake to an actuator in presence of a defect, in accessing, in a stop condition, and the like, by using a relatively simple device structure and a controlling method.

The nature, utility, and further features of this invention will be more clearly apparent from the following detailed description with reference to preferred embodiments of the invention when read in conjunction with the accompanying drawings briefly described below.

### BRIEF DESCRIPTION OF THE DRAWINGS

FIG. 1 is a block diagram showing an electrical-mechanical model on an actuator of voice coil type and its driving apparatus to explain a basic principle of the driving apparatus of an actuator of the present invention;

FIG. 2 is a block diagram showing an electrical model of the driving apparatus in FIG. 1;

FIG. 3 is a block diagram showing a feedback loop on a general driving apparatus to explain a basic principle of the driving apparatus of an actuator of the present invention;

FIG. 4 is a block diagram showing an electrical model of the feedback loop in FIG. 3;

FIG. 5 is a block diagram showing a feedback loop on a general driving apparatus to explain a basic principle of the driving apparatus of an actuator of the present invention;

FIG. 6 is a block diagram showing an electrical model of a general driving apparatus to explain a basic principle of the driving apparatus of an actuator of the present invention;

FIG. 7 is a block diagram showing an electrical model of a driving apparatus of an actuator associated with a first embodiment of the present invention;

FIG. 8 is a circuit diagram of the driving apparatus in FIG. 7;

FIG. 9 is a circuit diagram showing a principle of a driving apparatus of an actuator associated with a second embodiment of the present invention;

FIG. 10 is a schematic circuit diagram of the driving apparatus in FIG. 9;

FIG. 11 is a circuit diagram showing one concrete example of the driving apparatus in FIG. 10;

FIG. 12 is a circuit diagram showing another concrete example of the driving apparatus in FIG. 10;

FIG. 13 is a schematic circuit diagram showing a driving apparatus of an actuator associated with a third embodiment of the present invention;

FIG. 14 is a circuit diagram showing one concrete example of the driving apparatus in FIG. 13;

FIG. 15 is a circuit diagram showing another concrete example of the driving apparatus in FIG. 13;

FIG. 16 is a schematic circuit diagram showing a driving apparatus of an actuator associated with a fourth embodiment of the present invention;

FIG. 17 is a circuit diagram showing one concrete example of the driving apparatus in FIG. 16;

FIG. 18 is a block diagram showing an optical disc apparatus associated with a fifth embodiment of the present invention;

FIG. 19 is a timing chart showing one example of defect detection in the fifth embodiment;

FIG. 20 is a block diagram showing an optical disc apparatus associated with a sixth embodiment of the present invention; and

FIG. 21 is a block diagram showing an optical disc apparatus associated with a seventh embodiment of the present invention.

### DETAILED DESCRIPTION OF THE PREFERRED EMBODIMENTS

Referring to the accompanying drawings, embodiments of the present invention will be now explained.

(Basic Principle)

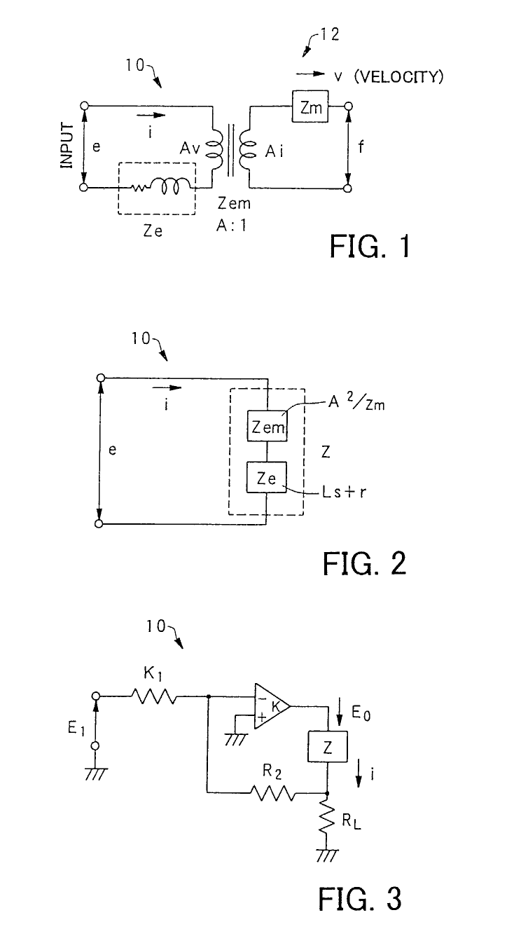

Firstly, the basic principle of the present invention will be explained with reference to FIG. 1 to FIG. 6.

In general, an electrical-mechanical model on an actuator of voice coil type and its driving apparatus is like FIG. 1.

In FIG. 1, a driving apparatus 10 of an actuator 12 is constructed to drive the actuator 12 on the basis of an electric current control. Namely, it is constructed to control the actuator 12 with electric current through a coil with the number of turns A: 1. More concretely, the driving apparatus 10 is constructed to move the actuator 12 at a velocity v according to an electric current i with respect to an input voltage e.

Here, the following equation (1) and equation (2) are applicable.

e=Zei+Av (1)

f=Zmv−Ai (2)

where

A: force constant (=Bl)

B: magnetic flux density

l: coil length

F: external force

and Av is counter electromotive force.

If the external force f=0 and the amount of the counter electromotive force converts to impedance Zem, since f=0, the above equation (2) can be rewritten:

v=Ai/Zm (2′)

Then, substituting this into the above equation (1) gives

e=(Ze+A²/Zm)i (3)

where the amount of counter electromotive force is

Zem=A²/Zm.

Hence, the electrical model of the driving apparatus 10 shown in FIG. 1 is as is the one shown in FIG. 2.

Incidentally, in FIG. 1 and FIG. 2,

L: coil inductance

r: internal resistance

Zm: mechanical impedance

Zem: the amount of counter electromotive force of the mechanical impedance out of impedance Z and

Ze: electrical impedance out of impedance Z.

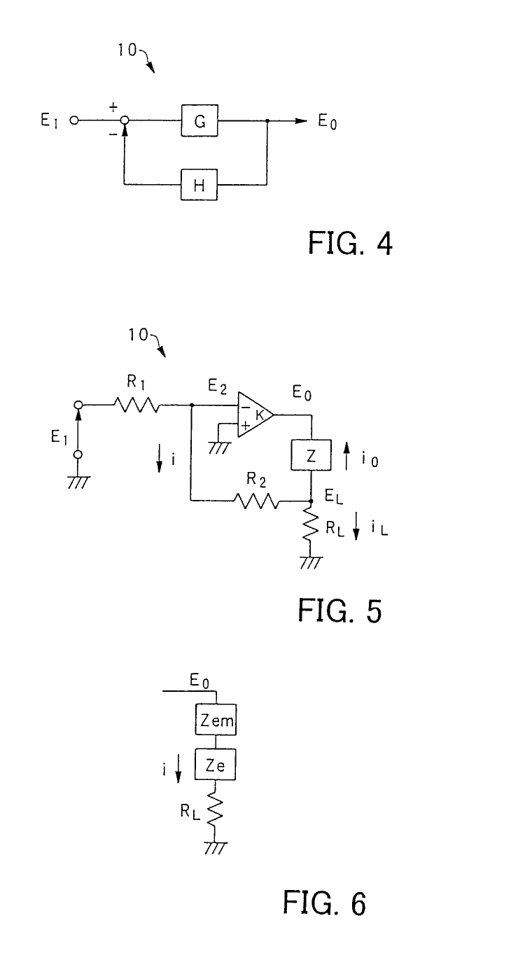

On the other hand, the driving apparatus 10, which is general, is like FIG. 3 and constructs a feedback loop shown in FIG. 4.

A circuit shown in FIG. 3 is a driving circuit referred to as current feedback and is intended to give feedback by monitoring an electric current flew into R_{L} (i.e. an electric current flew into the actuator 12), considering R2>>R_{L}.

Now, taking FIG. 4 into account, a transfer function is G/(1+GH) and a response function, which indicates a disturbance suppression characteristic, is 1/(1+GH). As it is smaller, it can counter disturbance more.

Thus, if GH is large, the driving apparatus 10 works to suppress a disturbance, which is counter electromotive force generated in the case that the actuator is still moving in spite of a try to stop the actuator (by making a drive input 0). In this case, as GH is larger, the brake performance of the actuator improves more.

When having FIG. 3 correspond to FIG. 4, the following equation (4) to equation (6) is applicable, with the op-amp gain as K.

$$\begin{matrix}G = \frac{{R}_{2} {R}_{L} + {R}_{L} Z + {R}_{2} Z}{{R}_{1} {R}_{L} + {R}_{2} {R}_{L} + {R}_{L} Z + {R}_{1} Z + {R}_{2} Z} \cdot K & ( 4 ) \\ H = \frac{{R}_{1} {R}_{Z}}{{R}_{2} {R}_{L} + {R}_{L} Z + {R}_{2} Z} & ( 5 ) \\ \begin{matrix}GH = \frac{{R}_{1} {R}_{Z}}{{R}_{1} {R}_{L} + {R}_{2} {R}_{L} + {R}_{L} Z + {R}_{1} Z + {R}_{2} Z} \cdot K \\ = \frac{K}{( 1 + {R}_{2} / {R}_{1} ) ( 1 + Z / {R}_{L} ) + Z / {R}_{1}}\end{matrix} & ( 6 )\end{matrix}$$

Here, a feedback is given even at a driving circuit as shown in FIG. 3 by counter electromotive force that comes with the movement of an actuator, while applying the brake to the actuator, which brings a braking operation but yet is not efficient. As its cause, it is conceivable that a feedback efficiency is not good, which will be explained in the following (i) and (ii).

(i) Namely, it is firstly conceivable that GH given by equation (7), which is obtained when Z<<R₁ in the equation (6), is not large enough.

$$GH = \frac{K}{( 1 + {R}_{2} / {R}_{1} ) ( 1 + Z / {R}_{L} )} \qquad ( 7 )$$

Namely, it is when R₂/R₁ or Z/R_{L} is large.

Here, the derivation of the equation (7) will be shown in the following.

Firstly, the following equation (101) to equation (106) is applicable on a circuit shown in FIG. 5.

$$\{ \begin{matrix} {E}_{2} = {E}_{1} - {R}_{1} i & ( 101 ) \\ {E}_{L} = {E}_{2} - {R}_{2} i & ( 102 ) \\ {E}_{L} = {R}_{L} {i}_{L} & ( 103 ) \\ {E}_{0} = {E}_{L} - {Zi}_{0} & ( 104 ) \\ {E}_{0} = - {AE}_{2} & ( 105 ) \\ i = {i}_{L} + {i}_{0} & ( 106 )\end{matrix}$$

The following equation (107) applies from the equations (101) and (105), thereby deriving equation (108).

E₀=−K(E₁−R₁i) (107)

$$∴ i = \frac{{E}_{1}}{{R}_{1}} + \frac{{E}_{0}}{{AR}_{1}} \qquad ( 108 )$$

Thus, the equation (101), the equation (102) and the equation (103) give the following equation (109), and the above equation (108) gives the following equation (110).

Rlil=E₁−(R₁+R₂)i (109)

$$\begin{matrix}{i}_{L} = \frac{{E}_{1}}{{R}_{L}} - \frac{{R}_{1} + {R}_{2}}{{R}_{L}} \\ = \frac{{E}_{1}}{{R}_{L}} - \frac{{R}_{1} + {R}_{2}}{{R}_{L}} ( \frac{{E}_{1}}{{R}_{1}} + \frac{{E}_{0}}{{AR}_{1}} ) \\ = \frac{{R}_{2}}{{R}_{1} {R}_{L}} {E}_{1} - \frac{{R}_{1} + {R}_{2}}{{AR}_{1} {R}_{L}} {E}_{0}\end{matrix} \qquad ( 110 )$$

On the other hand, the above equations (103) and (104) give the following equations(111) and (112).

E₀=Rlil−Zi₀ (111)

$$\begin{matrix}{i}_{0} = - \frac{{E}_{0}}{Z} + \frac{{R}_{L}}{Z} {i}_{L} \\ = - \frac{{E}_{0}}{Z} + \frac{{R}_{L}}{Z} ( \frac{{R}_{2}}{{R}_{1} {R}_{L}} {E}_{1} - \frac{{R}_{1} + {R}_{2}}{{AR}_{1} {R}_{L}} {E}_{0} ) \\ = \frac{{R}_{2}}{{R}_{1} Z} {E}_{1} - \frac{{KR}_{1} + {R}_{1} + {R}_{2}}{{KR}_{1} Z} {E}_{0}\end{matrix} \qquad ( 112 )$$

Finally, the above equations (106), (108), (110), and (112) give GH (=E₀/E₁) as follows.

$$\begin{matrix}\frac{{E}_{1}}{{R}_{1}} + \frac{{E}_{0}}{{KR}_{1}} = \frac{{R}_{2}}{{R}_{1} {R}_{L}} {E}_{1} - \frac{{R}_{1} + {R}_{2}}{{KR}_{1} {R}_{L}} {E}_{0} + \frac{{R}_{2}}{{R}_{1} Z} {E}_{1} - \frac{{KR}_{1} + {R}_{1} + {R}_{2}}{{KR}_{1} Z} {E}_{0} \\ \frac{{E}_{0}}{{E}_{1}} = \frac{K ( {R}_{2} {R}_{L} + {R}_{L} Z + {R}_{2} Z )}{{KR}_{1} {R}_{L} + {R}_{1} {R}_{L} + {R}_{2} {R}_{L} + {R}_{L} Z + {R}_{1} Z + {R}_{2} Z} \\ = \frac{K \cdot \frac{{R}_{2} {R}_{L} + {R}_{L} Z + {R}_{2} Z}{{R}_{1} {R}_{L} + {R}_{2} {R}_{L} + {R}_{L} Z + {R}_{1} Z + {R}_{2} Z}}{1 + \frac{{KR}_{1} {R}_{L}}{{R}_{1} {R}_{L} + {R}_{2} {R}_{L} + {R}_{L} Z + {R}_{1} Z + {R}_{2} Z}}\end{matrix}$$

(ii) Secondly, it is conceivable that current monitor sensitivity is small. This cause may be considered as follows. The feedback of a voltage increase caused by R_{L} and by a counter electromotive current is given in a driving circuit of current feedback type. If the electromotive current is small and R_{L} is small, the efficiency of feedback becomes worse.

Suppose a counter electromotive current i generates at Zem as shown in FIG. 6, considering FIG. 2 and FIG. 3. A predetermined feedback efficiency is not obtained unless R_{L} is large to Ze+Zem.

In this case, R_{L} is set extremely small to obtain a current efficiency in typical driving. If an addition of a switch or the like is desired, its ON resistance will be a problem and it is not practical.

(I) First Embodiment

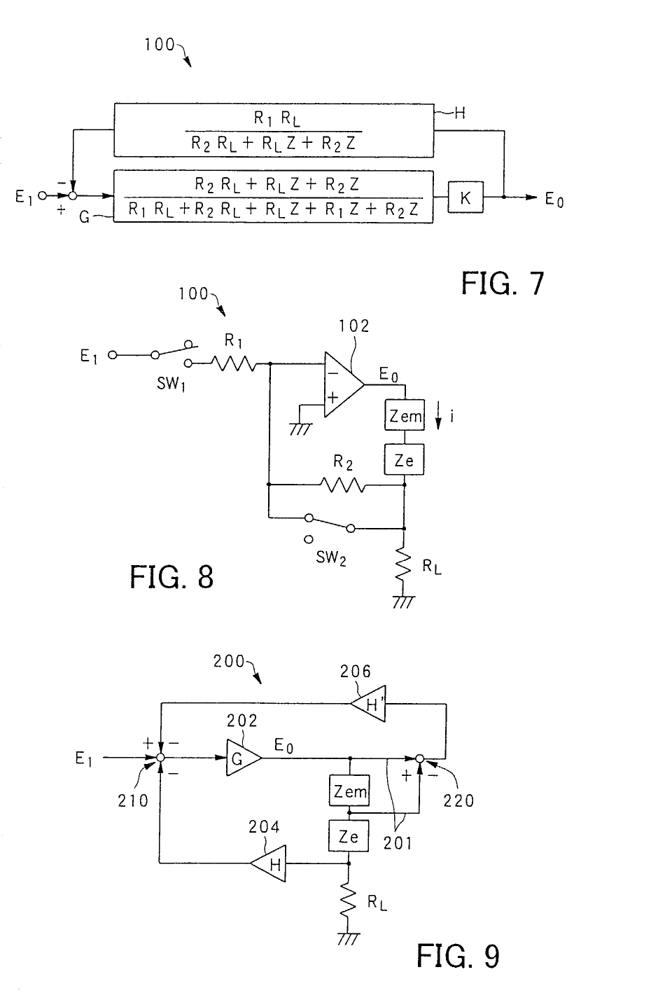

Next, the first embodiment of the present invention based on the above-described basic principal will be explained with reference to FIG. 7 and FIG. 8. FIG. 7 is a block diagram showing an electrical model in the first embodiment. FIG. 8 is its circuit diagram.

As shown in FIG. 7 and FIG. 8, a driving apparatus 100 in the first embodiment is intended to drive an actuator for driving tracking or for driving focus of an optical pickup, for example. The driving apparatus 100 is provided with: a resistance R_{L}, which constitutes one example of a current monitor device for generating a voltage corresponding to an electric current that passes through the actuator and that includes a component corresponding to a counter electromotive force generated according to a movement of the actuator (Hereafter referred to as a counter electromotive force component); a resistance R₂, which constitutes one example of a feedback device for giving negative feedback on the basis of the voltage generated in the resistance R_{L}; a switch SW2; and an op-amp 102, both of which are connected in parallel to the resistance R₂.

Especially, the first embodiment is designed such that the resistance R₂ can become small by the switch SW2 in order to reduce a gain GH shown in the equation (7). Alternatively, it is designed such that the resistance R_{L} or the resistance R₁ is large. However, from among these, increasing the resistance R_{L} is not practical as described above. Reducing the resistance R₂ with the switch SW2 gives a small gain GH of E₀/E₁, which gives a large effect if a wrong input is performed in presence of a defect and the like.

Namely, at the driving apparatus 100, the negative feedback of the voltage generated by the resistance R_{L} is given selectively through the switch SW2 and the resistance R₂ or only through the resistance R₂ by opening and closing the switch SW2. Then, for example, in presence of a defect, in slider movement, in a stop condition, or the like, the switch SW2 is closed according to a first braking signal. This can make it difficult for an actuator, such as the one for tracking control or the one for focus control, to move according to a relatively large feedback gain, when the counter electromotive force is generated. On the other hand, in typical operation, the switch SW2 is opened according to the first braking signal. This does not make it difficult for an actuator, such as the one for tracking control or the one for focus control, to move according to a relatively small feedback gain.

As a result of these, it becomes possible to apply the brake to an actuator in presence of a defect, in accessing, in a stop condition, or the like, as well as simplifying the machine structure of a driving apparatus and its control method. In this case, it is not necessary to install a braking mechanism such as a brake or the like apart from a driving mechanism of the actuator, and also it is not necessary to control this by a CPU or the like.

In addition, a switch SW1, which constitutes one example of a first switch device on an input route, is disposed in the first embodiment. Therefore, in presence of a defect, in slider movement, in a stop condition, or the like, it is possible to give negative feedback of a voltage corresponding to such an electric current that only includes the counter electromotive force component generated according to the movement of the actuator, by opening the switch SW1 according to a second braking signal to cut the input route. On the other hand, in typical operation, it is possible to input an electric current for driving, by closing the switch SW1 according to the second braking signal.

As for the switch SW1, since there is such a case that a big shock is added to an input when a situation is changed between typical operations and the presence of a defect, slider movement, a stop condition, or the like, it is possible not to install it. Moreover, a control signal for controlling the switch SW1 and a control signal for controlling the switch SW2 may be identical ones or may be different ones.

(II) Second Embodiment

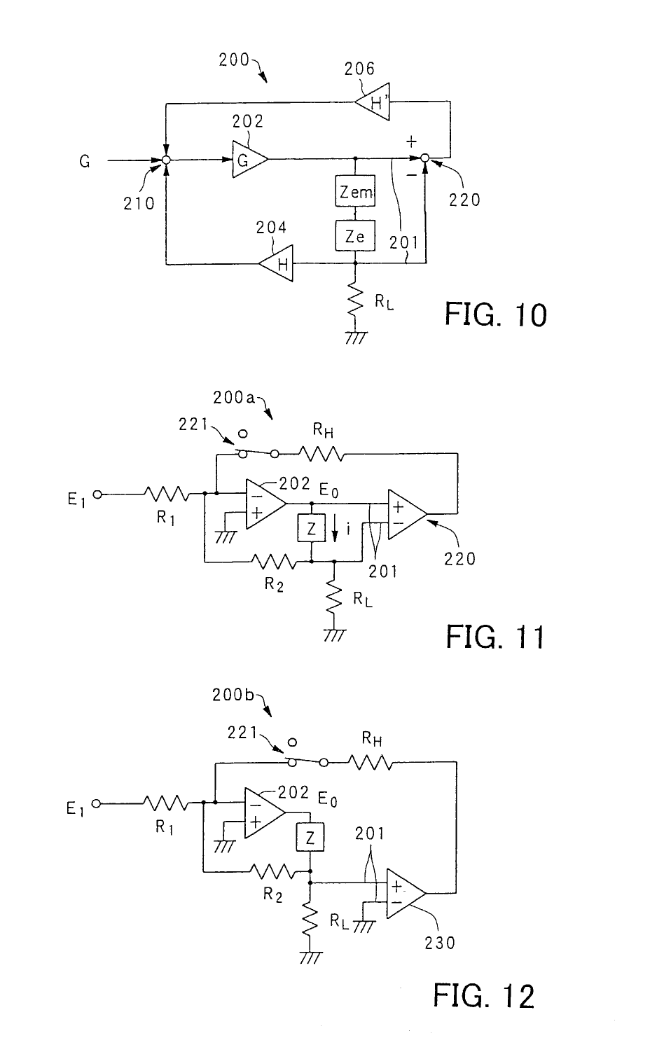

Next, the second embodiment of the present invention based on the above-described basic principle will be explained with reference to FIG. 9 to FIG. 12. FIG. 9 is a circuit diagram showing a principle of the second embodiment. FIG. 10 is its schematic circuit diagram. FIG. 11 is a circuit diagram showing one concrete example of it. FIG. 12 is a circuit diagram showing another concrete example.

As shown in FIG. 9, a driving apparatus 200 in the second embodiment is intended to drive an actuator for driving tracking or for driving focus of an optical pickup, for example. The driving apparatus 200 is provided with: a monitor route 201 and the resistance R_{L}, which constitute one example of a current monitor device for generating a voltage corresponding to an electric current that passes through the actuator and that includes a counter electromotive force component generated according to a movement of the actuator; an adder 210, an adder 220, an op-amp 202, an op-amp 204, and an op-amp 206, which constitute one example of a feedback device for selectively giving negative feedback of the voltage generated in the monitor route 201 and the resistance R_{L} with a first gain or a second gain, which is larger than the first gain.

Especially, in the second embodiment, an amplifier circuit is used in order to increase the amount of feedback. In the case of reducing the resistance R₂ as described in the first embodiment, the resistance R_{L} does not monitor a driving current i, so that it is designed to monitor the amount of counter electromotive force through the monitor route 201.

In FIG. 9, the monitor route 201 branches off from between Zem and Ze so as to monitor the amount of counter electromotive force. However, since these mechanical impedance and electrical impedance are both in one and inseparable, the monitor route 201 is practically placed at a location shown in FIG. 10.

In FIG. 11, a driving circuit 200a as one concrete example of a circuit shown in FIG. 10 is equipped with a feedback loop that gives feedback to the op-amp 202 through the resistance R₂ with one gain; the op-amp 220; and a feedback loop that gives feedback to the op-amp 202 through the resistance R_{H} and a switch 221 with another gain.

Namely, at the driving circuit 200a, the negative feedback of the voltage generated by the resistance R_{L} is given selectively through the op-amp 220, the resistance R_{H}, and the switch SW221 or only through the resistance R₂ by opening-closing of the switch SW221. Then, for example, in presence of a defect, in slider movement, in a stop condition, or the like, the switch SW221 is closed according to the first braking signal. This can make it difficult for an actuator, such as the one for tracking control or the one for focus control, to move according to a relatively large feedback gain, when the counter electromotive force is generated. On the other hand, in typical operation, the switch SW221 is opened according to the first braking signal. This does not make it difficult for an actuator, such as the one for tracking control or the one for focus control, to move according to a relatively small feedback gain.

As a result of these, it becomes possible to apply the brake to an actuator in presence of a defect, in accessing, in a stop condition, or the like, as well as simplifying the machine structure of a driving apparatus and its control method. In this case, it is not necessary to install a braking mechanism such as a brake or the like apart from a driving mechanism of the actuator, and also it is not necessary to control this by a CPU or the like.

Incidentally, as another concrete example of the second embodiment shown in FIG. 10, if the resistance R₂ is large, a driving circuit 200b may be equipped with a feedback loop that gives feedback to the op-amp 202 through the resistance R₂ with one gain; an op-amp 230 whose minus input terminal side is earthed; and a feedback loop that gives feedback to the op-amp 202 through the resistance R_{H} and the switch 221 with another gain, as shown in FIG. 12.

(III) Third Embodiment

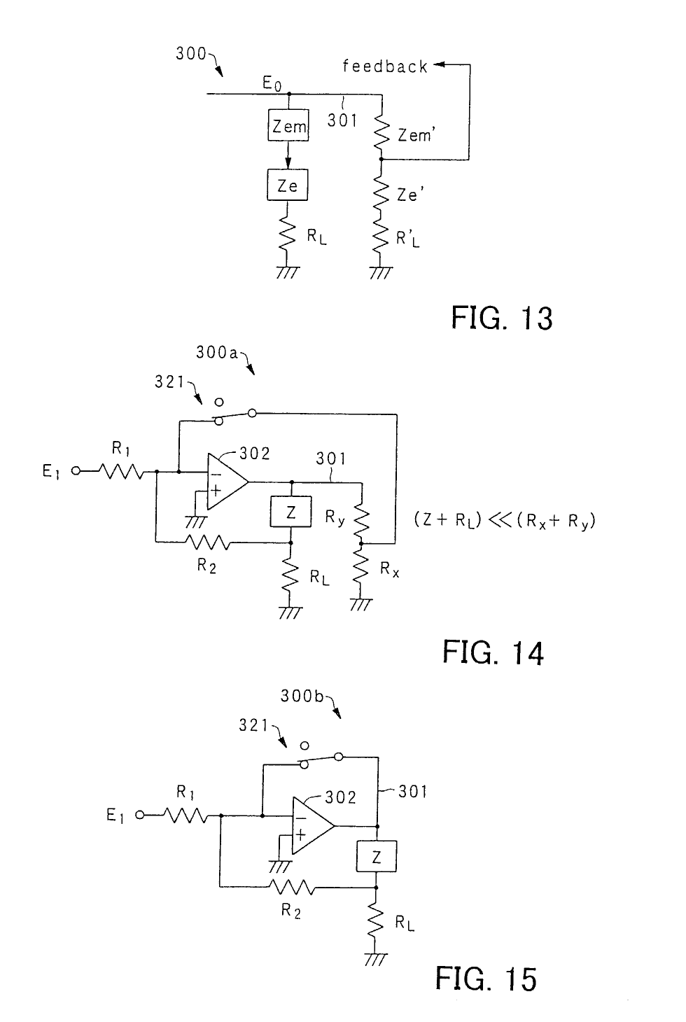

Next, the third embodiment of the present invention based on the above-described basic principle will be explained with reference to FIG. 13 to FIG. 15. FIG. 13 is a schematic circuit diagram of the third embodiment. FIG. 14 is a circuit diagram showing one concrete example of it. FIG. 15 is a circuit diagram showing another concrete example.

As shown in FIG. 13, a driving apparatus 300 in the third embodiment is intended to drive an actuator for driving tracking or for driving focus of an optical pickup, for example. In order to increase feedback sensitivity, the driving apparatus 300 is provided with: a monitor route 301, which constitutes one example of a current monitor device for generating a voltage corresponding to an electric current that passes through the actuator and that includes a counter electromotive force component generated according to a movement of the actuator; an impedance Zem′ and an impedance Ze′; and a resistance R_{L}′. To easily understand, FIG. 13 shows correspondence as follows: Zem→Zem′, Ze→Ze′, and R_{L}→R_{L}′.

In this case, to prevent from giving damage on driving in typical operation, preferably, Zem<<Zem′, Ze<<Ze′, and R_{L}<<R_{L}′. Since a feedback gain can be set arbitrarily, the ratios of Zem′, Ze′, and R_{L}′ are also arbitrary.

In FIG. 14, a driving circuit 300a as one concrete example of a circuit shown in FIG. 13 is equipped with: a feedback loop that gives feedback to an op-amp 302 through the resistance R₂ with one gain; and a feedback loop that gives feedback to the op-amp 302 through a switch 321 from between the resistance R_{X} and the resistance R_{Y} with another gain.

Namely, at the driving circuit 300a, the negative feedback of the voltage generated between the resistance R_{X} and the resistance R_{Y} is given selectively through the switch SW321 or only through the resistance R₂ by opening-closing of the switch SW321. Then, for example, in presence of a defect, in slider movement, in a stop condition, or the like, the switch SW321 is closed according to the first braking signal. This can make it difficult for an actuator, such as the one for tracking control or the one for focus control, to move according to a relatively large feedback gain, when the counter electromotive force is generated. On the other hand, in typical operation, the switch SW321 is opened according to the first braking signal. This does not make it difficult for an actuator, such as the one for tracking control or the one for focus control, to move according to a relatively small feedback gain.

As a result of these, it becomes possible to apply the brake to an actuator in presence of a defect, in accessing, in a stop condition, or the like, as well as simplifying the machine structure of a driving apparatus and its control method. In this case, it is not necessary to install a braking mechanism such as a brake or the like apart from a driving mechanism of the actuator, and also it is not necessary to control this by a CPU or the like.

Incidentally, under a structure shown in FIG. 14, a feedback gain increases when the resistance R_{Y}→small and the resistance R_{X}→large.

Then, as another concrete example of the third embodiment shown in FIG. 13, if the feedback gain is set to be the largest under the structure shown in FIG. 14, i.e. if the resistance Rₓ→0 and the resistance R_{Y}→0, a driving circuit 300b may be equipped with: a feedback loop that gives feedback to the op-amp 302 through the resistance R₂ with one gain; and a feedback loop that gives feedback to the op-amp 302 through the monitor route 301 and the switch 321 with another gain, as shown in FIG. 15. Considering this with such an idea that the resistance R₁ and the resistance R₂ are large, an actuator and a return resistance are formed to hang on voltage follower obtained with an input of 0V when the actuator applies the brake.

(IV) Fourth Embodiment

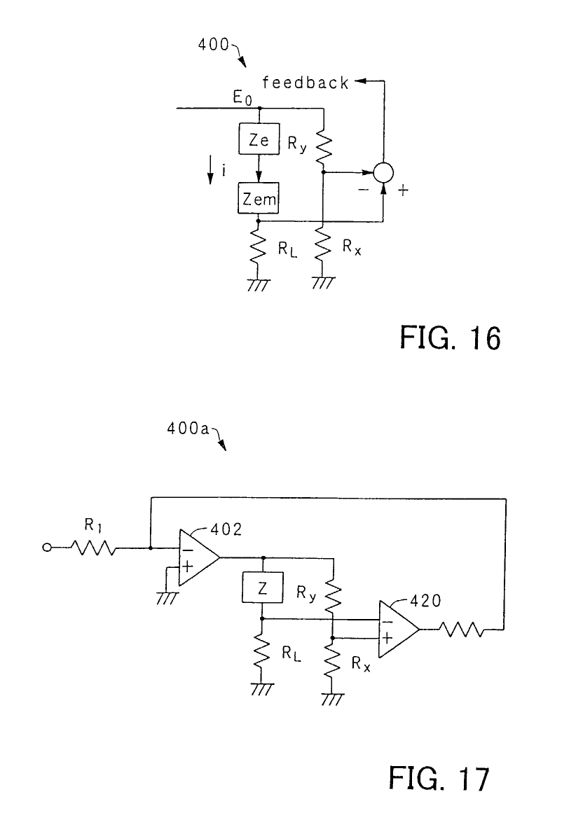

Next, the fourth embodiment of the present invention based on the above-described basic principle will be explained with reference to FIG. 16 and FIG. 17. FIG. 16 is a schematic circuit diagram of the fourth embodiment. FIG. 17 is a circuit diagram showing one concrete example of it.

As shown in FIG. 16, a driving apparatus 400 in the fourth embodiment is intended to drive an actuator for driving tracking or for driving focus of an optical pickup, for example. The driving apparatus 400 is provided with three resistances R_{L}, R_{X}, and R_{Y} as another example of a current monitor device and is constructed to generate a voltage corresponding to the counter electromotive force component of by these resistances. More concretely, since each resistance value is set as being Ze: R_{X}=R_{Y}: R_{X}, it can monitor only the counter electromotive force component.

In FIG. 17, a driving circuit 400a as one concrete example of the circuit shown in FIG. 16 is equipped with a feedback loop that gives feedback to an op-amp 402 without passing through any resistance nor a switch but through an op-amp 420 whose input terminal is connected to a non-grounded side of the resistance R_{L} and between the resistances R_{X} and the resistances R_{Y}.

Namely, the feedback of only the counter electromotive force component obtained by these resistances is given at the driving circuit 400a, so that even if it uses a large feedback gain, that does not give any damage in typical operation. In other words, since it is only a current feedback to correct the counter electromotive force component, it is possible to hold a drive gain appropriately. Therefore, it is not necessary to have a switch that works only when applying the brake to an actuator, so that the fourth embodiment is extremely useful to simplify the machine structure and its control.

As a result, it becomes possible to apply the brake to an actuator in presence of a defect, in accessing, in a stop condition, or the like, as well as simplifying the machine structure of a driving apparatus and its control method. In this case, it is not necessary to install a braking mechanism such as a brake or the like apart from a driving mechanism of the actuator, and also it is not necessary to control this by a CPU or the like.

Incidentally, monitoring only the counter electromotive force component is equal to using a sensor for monitoring the movement of an actuator in the fourth embodiment. Thus, it is possible to apply the brake (“lens middle-point servo” could be used to refer to this) without any detection of a signal or the like and without any sensor.

(V) Fifth Embodiment

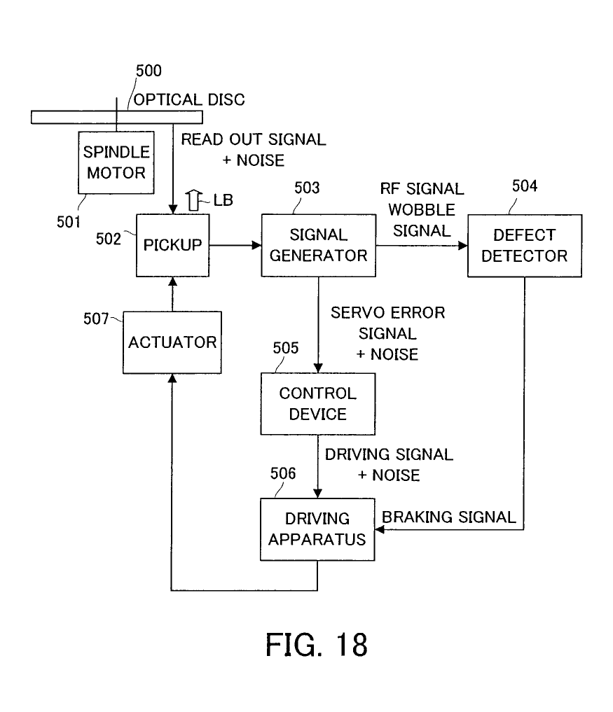

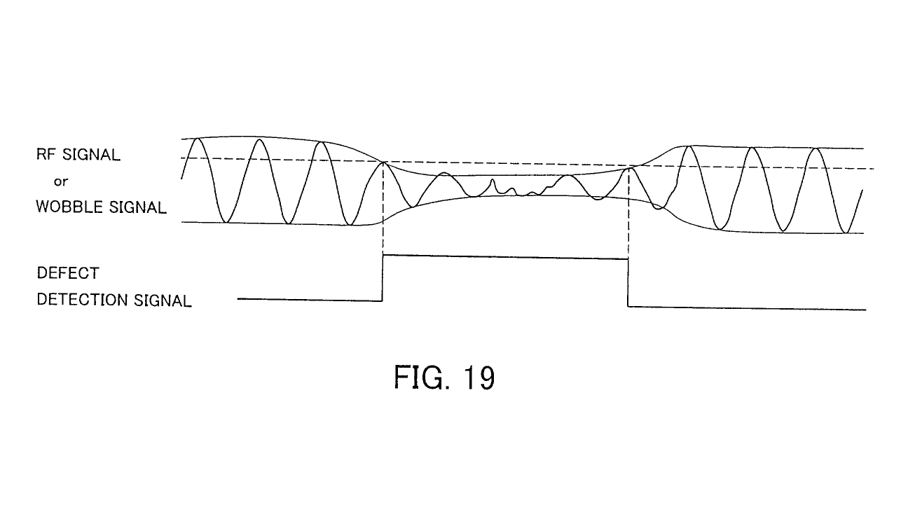

Next, the fifth embodiment associated with an optical disc apparatus as one example of an information recording/reproducing apparatus, which is equipped with any one of the driving apparatuses in the above-described first to fourth embodiment, will be explained with reference to FIG. 18 and FIG. 19. FIG. 18 is a block diagram showing an optical disc apparatus in the fifth embodiment. FIG. 19 is a timing chart showing one example of defect detection in the fifth embodiment.

In FIG. 18, the optical disc apparatus in the fifth embodiment is constructed to include: a spindle motor 501, an optical pickup 502, a signal generator 503, a defect detector 504, a control device 505, a driving apparatus 506, and an actuator 507 so as to perform at least one of optical recording and optical reproducing of information on an optical disc 500.

The spindle motor 501 is a motor for spinning the optical disc 500 at a predetermined rotational frequency. The optical pickup 502 irradiates the optical disc 500 with a laser beam for reading or for writing information onto the optical disc 500, and at the same time, it receives the reflected light and outputs a received signal. On the basis of this received signal, the signal generator 503 generates various signals including a wobble signal corresponding to a wobbling record track or a guide track disposed on the optical disc 500, a RF (Radio Frequency) signal, and the like, in addition to a servo error signal, such as a tracking error signal, a focus error signal, and the like, and noise.

Then, the defect detector 504 always monitors the average amplitude of the wobble signal or the RF signal, as shown in FIG. 19 (refer to an upper part of FIG. 19), which is generated by the signal generator 503. In the case that this amplitude becomes less than a predetermined threshold, considering that there is a defect, it outputs a defect detection signal (refer to a lower part of FIG. 19) as a braking signal at a high level.

The control device 505 is constructed by a CPU or the like, and it generates a driving signal for driving the driving apparatus 506 and noise on the basis of the servo error signal and the noise outputted from the signal generator 503. The driving apparatus 506 drives the actuator 507 of various types, such as the one for tracking and for focus, according to the driving signal and the noise from the control device 505. Especially, in the fifth embodiment, the driving apparatus 506 is constructed from any one of the driving apparatuses in the above-described first to fourth embodiment. Then, the optical pickup 502 is constructed to move an appropriate position and to correct a posture quickly by having its position, its posture, and the like moved by the actuator 507.

According to the optical disc apparatus associated with the fifth embodiment, when a defect is generated on the optical pickup 502 on which the actuator 507 is disposed, a braking signal is supplied by the defect detector 504. Then, according to this, a switch(es) (e.g. SW2 in FIG. 8 or the like) disposed inside the driving apparatus 506 is opened or closed, or a gain associated with negative feedback at a feedback device is changed. Alternatively, negative feedback of the counter electromotive force component is constantly given regardless of the braking signal, i.e. regardless of the switch. Therefore, it is possible to prevent the actuator 507 from reacting an error signal excessively in presence of a defect, so that it is not necessary to operate the actuator 507 beyond the limits and inappropriately.

Incidentally, FIG. 18 shows main constitutional elements, which are related to driving of the actuator 507 associated with the fifth embodiment and which are extracted from among the optical disc apparatus. The optical disc apparatus may be constructed to include other general various constitutional elements.

(VI) Six Embodiment

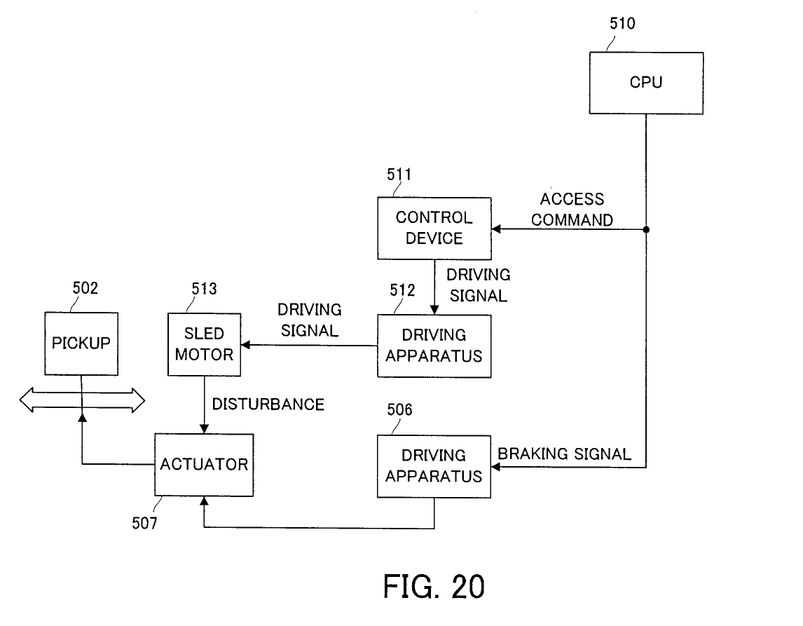

Next, the sixth embodiment associated with an optical disc apparatus as one example of an information recording/reproducing apparatus, which is equipped with any one of the driving apparatuses in the above-described first to fourth embodiment, will be explained with reference to FIG. 20. FIG. 20 is a block diagram showing an optical disc apparatus in the sixth embodiment. Incidentally, in FIG. 20, the same constitutional elements as those in the fifth embodiment shown in FIG. 18 carry the same reference numerals and the detailed explanations of them are omitted.

In FIG. 20, the optical disc apparatus in the sixth embodiment is provided with the optical pickup 502, the driving apparatus 506, and the actuator 507, and it further includes a CPU 510, a control deice 511, a driving apparatus 512, and a sled motor 513.

The CPU 510 outputs a braking signal as well as an access command depending on an address to be accessed so as to read out or to write. The control device 511 generates a driving signal on the basis of this access command and outputs it to the driving apparatus 512. Then, the driving apparatus 512 drives the sled motor 513 on the basis of this driving signal. Namely, the sled motor 513 has the optical pickup 502 perform slider or carriage movement with the address corresponding to the access command as a target.

According to the optical disc apparatus associated with the sixth embodiment, a gain associated with negative feedback is increased, as described above, by switching on-off or the like at the driving apparatus 506 of the actuator 507, depending on the braking signal outputted from the CPU 510. This temporarily and transiently makes it difficult for the actuator 507 to move. Therefore, it is possible to prevent the actuator 507, such as the one for focus control and the one for tracking control and the like, from wobbling greatly in slider movement or carriage movement by the sled motor 513, so that it is possible to perform an excellent tracking control and focus control immediately after accessing, as well as decreasing the cause of troubles.

Incidentally, FIG. 20 shows main constitutional elements, which are related to driving of the actuator 507 associated with the sixth embodiment and which are extracted from among the optical disc apparatus. The optical disc apparatus may be constructed to include various other general constitutional elements.

(VII) Seventh Embodiment

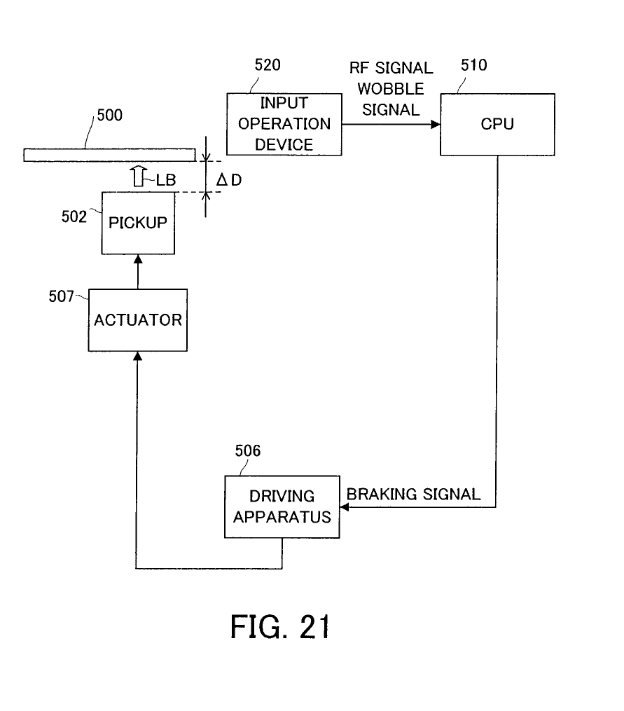

Next, the seventh embodiment associated with an optical disc apparatus as one example of an information recording/reproducing apparatus, which is equipped with any one of the driving apparatus in the above-described first to fourth embodiment, will be explained with reference to FIG. 21. FIG. 21 is a block diagram showing an optical disc apparatus in the seventh embodiment. Incidentally, in FIG. 21, the same constitutional elements as those in the fifth embodiment shown in FIG. 18 or as those in the sixth embodiment shown in FIG. 20 carry the same reference numerals and the detailed explanations of them are omitted.

In FIG. 21, the optical disc apparatus in the seventh embodiment is provided with the optical pickup 502, the driving apparatus 506, and the actuator 507, and it further includes the CPU 510 and an input operation device 520.

The CPU 510 performs operations corresponding to various operation commands inputted through the input operation device 520 such as a touch panel, a key, a button, an audio input device, and the like, according to a predetermined program. Especially, it monitors whether or not predetermined commands that cause a stop condition of the optical disc apparatus, such as the device's main switch off, radio reception, reproduction of other media, temporal and transient operation stop by the optical pickup 502 at the optical disc device, and the like, is inputted. Then, when such a command is inputted through the input operation device 520, the CPU 510 outputs a braking signal to the driving apparatus 506.

According to the optical disc apparatus associated with the seventh embodiment, a gain associated with negative feedback is increased, as described above, by switching on-off or the like at the driving apparatus 506 of the actuator 507, depending on the braking signal outputted from the CPU 510. This makes it difficult for the actuator 507 to move. Therefore, it is possible to prevent the actuator 507's wobble caused by the vibration of a vehicle or by carrying in a stop condition of the optical disc apparatus or the optical pickup. Especially, it is possible to avoid the possibility that the optical pickup 502 bumps into or crashes into a face of the optical disc 500 whose distance A D from the optical pickup 502 is extremely small as shown in FIG. 21.

Incidentally, FIG. 21 shows main constitutional elements, which are related to the driving of the actuator 507 associated with the seventh embodiment and which are extracted from among the optical disc apparatus. The optical disc apparatus may be constructed to include various other general constitutional elements.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2001-260355 filed on Aug. 29, 2001 including the specification, claims, drawings and summary is incorporated herein by reference in its entirety.

What is claimed is:

1. A driving apparatus for driving an actuator according to electric current control, comprising:
a current monitor device for generating a voltage corresponding to an electric current that passes through the actuator and that includes a counter electromotive force component generated according to a movement of the actuator; and
a feedback device for giving negative feedback of the generated voltage.

2. A driving apparatus according to claim 1, wherein said current monitor device generates a voltage corresponding to the counter electromotive force component.

3. A driving apparatus according to claim 2, wherein said current monitor device comprises:
a first resistance connected between a ground and one terminal of an input side of an inductance which electromagnetically generates driving force for driving the actuator;
a second resistance connected between said first resistance and the one terminal of the input side of the inductance; and
a third resistance connected between the ground and another terminal of the inductance, and
Ze:R_{L}=R_{Y}:R_{X}
is applicable when an electric impedance of the inductance is Ze and values of said first resistance, said second resistance, and said third resistance are R_{X}, R_{L}, and R_{Y}, respectively.

4. A driving apparatus according claim 1, wherein said feedback device comprises a first switch device to be opened or closed according to a first braking signal, and gives negative feedback of the generated voltage selectively by opening or closing said first switch device.

5. A driving apparatus according to claim 4, wherein said feedback device comprises a resistance connected in parallel to said first switch device.

6. A driving apparatus according to claim 4, comprising a second switch device to be opened or closed according to a second braking signal on an electric current input route for driving of the actuator.

7. A driving apparatus according to claim 6, wherein a single common signal is used as the first braking signal and the second braking signal.

8. A driving apparatus according to claim 4, wherein the first braking signal is supplied in response to presence of a defect of a recording medium, when a recording operation or a reproducing operation is performed on the recording medium through a pickup on which the actuator is disposed.

9. A driving apparatus according to claim 8, further comprising a control device for detecting the defect on the basis of an optical detection signal outputted by the pickup, wherein
said control device outputs the first braking signal in response to the detection of the defect.

10. A driving apparatus according to claim 4, wherein the first braking signal is supplied when a slider movement or a carriage movement of a pickup on which the actuator is disposed occurs.

11. A driving apparatus according to claim 10, further comprising a control device for outputting an access command that orders the pickup to perform the slider movement or the carriage movement to a predetermined address location on a recording medium,
said control device outputting the first braking signal in response to the output of the access command.

12. A driving apparatus according to claim 4, wherein the first braking signal is supplied in a stop condition of an operation of a pickup on which the actuator is disposed.

13. A driving apparatus according to claim 12, further comprising a control device for determining whether or not the pickup is in a stop condition,
said control device outputting the first braking signal in response to the determination of being in the stop condition of the pickup.

14. A driving apparatus according to claim 6, wherein the second braking signal is supplied in response to presence of a defect of a recording medium, when a recording operation or a reproducing operation is performed on the recording medium through a pickup on which the actuator is disposed.

15. A driving apparatus according to claim 14, further comprising a control device for detecting the defect on the basis of an optical detection signal outputted by the pickup, wherein
said control device outputs the second braking signal in response to the detection of the defect.

16. A driving apparatus according to claim 6, wherein the second braking signal is supplied when a slider movement or a carriage movement of a pickup on which the actuator is disposed occurs.

17. A driving apparatus according to claim 16, further comprising a control device for outputting an access command that order to perform the pickup the slider movement or the carriage movement to a predetermined address location on a recording medium,
said control device outputting the second braking signal in response to the output of the access command.

18. A driving apparatus according to claim 6, wherein the second braking signal is supplied in a stop condition of an operation of a pickup on which the actuator is disposed.

19. A driving apparatus according to claim 18, further comprising a control device for determining whether or not the pickup is in a stop condition,
said control device outputting the second braking signal in response to the determination of being in the stop condition of the pickup.

20. A driving apparatus according to claim 1, wherein
said feedback device comprises an amplification device for amplifying the generated voltage, and gives negative feedback of the amplified voltage.

21. A driving apparatus according to claim 20, wherein said feedback device further comprises a resistance connected in parallel to said amplification device.

22. A driving apparatus according to claim 1, wherein the actuator is the one for tracking driving or the one for focus driving of a pickup.

23. A driving apparatus for driving an actuator according to electric current control, comprising:
a current monitor device for generating a voltage corresponding to an electric current that passes through the actuator; and
a feedback device for selectively giving negative feedback of the generated voltage with a first gain or a second gain, which is larger than the first gain, according to a first braking signal.

24. A driving apparatus according to claim 23, wherein the first braking signal is supplied in response to presence of a defect of a recording medium, when a recording operation or a reproducing operation is performed on the recording medium through a pickup on which the actuator is disposed.

25. A driving apparatus according to claim 24, further comprising a control device for detecting the defect on the basis of an optical detection signal outputted by the pickup, wherein
said control device outputs the first braking signal in response to the detection of the defect.

26. A driving apparatus according to claim 23, wherein the first braking signal is supplied when a slider movement or a carriage movement of a pickup on which the actuator is disposed occurs.

27. A driving apparatus according to claim 26, further comprising a control device for outputting an access command that orders the pickup to perform the slider movement or the carriage movement to a predetermined address location on a recording medium,
said control device outputting the first braking signal in response to the output of the access command.

28. A driving apparatus according to claim 23, wherein the first braking signal is supplied in a stop condition of an operation of a pickup on which the actuator is disposed.

29. A driving apparatus according to claim 28, further comprising a control device for determining whether or not the pickup is in a stop condition,
said control device outputting the first braking signal in response to the determination of being in the stop condition of the pickup.

30. A driving apparatus according to claim 23, wherein
said feedback device comprises an amplification device for amplifying the generated voltage, and gives negative feedback of the amplified voltage.

31. A driving apparatus according to claim 30, wherein said feedback device further comprises a resistance connected in parallel to said amplification device.

32. A driving apparatus according to claim 23, wherein the actuator is the one for tracking driving or the one for focus driving of a pickup.

33. A driving method of driving an actuator according to electric current control, comprising:
a current monitor process of generating a voltage corresponding to an electric current that passes through the actuator and that includes a counter electromotive force component generated according to a movement of the actuator; and
a feedback process of giving negative feedback of the generated voltage.

34. A driving method of driving an actuator according to electric current control, comprising:
a current monitor process of generating a voltage corresponding to an electric current that passes through the actuator; and
a feedback process of selectively giving negative feedback of the generated voltage with a first gain or a second gain, which is larger than the first gain, according to a first braking signal.

35. An information recording/reproducing apparatus comprising:
a driving apparatus for an actuator;
the actuator;
a pickup movable by the actuator; and
an information recording/reproducing device for performing at least one of record and reproduction of information by the pickup, said driving apparatus comprising:
a current monitor device for generating a voltage corresponding to an electric current that passes through the actuator and that includes a counter electromotive force component generated according to a movement of the actuator; and
a feedback device for giving negative feedback of the generated voltage.

36. An information recording/reproducing apparatus comprising:
a driving apparatus for an actuator;
the actuator;
a pickup movable by the actuator; and
an information recording/reproducing device for performing at least one of record and reproduction of information by the pickup, said driving apparatus comprising:
a current monitor device for generating a voltage corresponding to an electric current that passes through the actuator; and
a feedback device for selectively giving negative feedback of the generated voltage with a first gain or a second gain, which is larger than the first gain, according to a first braking signal.
